(19) United States
(12) Patent Application Publication
(10) Pub. No.: US 2007/0269622 A1
(43) Pub. Date: Nov. 22, 2007

(54) MICROLAYER LOW SCALPING BARRIER PACKAGING MATERIAL

(75) Inventors: Ann Marie Chuprevich, Blaine, MN (US); Mats Bentmar, Svedela (SE)

Correspondence Address: TETRA PAK US INTELLECTUAL PROPERTY DEPARTMENT;TETRA PAK INC., 101 COPORATE WOODS PARKWAY, VERNON HILLS, IL, 60061, US

(73) Assignee: TETRA LAVAL HOLDINGS & FINANCE S.A., Pully (CH)

(21) Appl. No.: 11/419,359

(22) Filed: May 19, 2006

(51) Int. Cl. B32B 27/10

(52) U.S. Cl. 428/34.2

(57) ABSTRACT

A low scalping laminate material for food packaging is formed from a core layer of paper or paperboard having a first side and as second side. A polymeric coating is applied to the first side of the core layer. A food contacting barrier layer is disposed on the second side of the core layer. The food contacting barrier layer is formed from a plurality of series of layers of polymeric materials. Each series of layers includes a polyolefin layer, a tie layer, a polyamide resin layer, a tie layer and a polyolefin layer. The plurality is a whole number greater than one and the layers are applied to provide a weight ratio of materials in each series of 15:46 for each of the polyolefin layers, 5:46 for each of the tie layers and 6:46 for the polyamide resin layer. A low scalping carton is also disclosed.

### BACKGROUND OF THE INVENTION

The present invention relates to a low scalping barrier material for packaging. More particularly, the present invention relates to a low scalping barrier material for packaging that provides enhanced barrier properties with as well as an oxygen barrier.

Laminated materials are common and in wide-spread for use in liquid food packaging. A typical laminated material is formed from a relatively rigid but foldable paper or paperboard core layer onto which one or more liquid tight coatings of plastic are applied. These laminates provide good mechanical configurational stability and are relatively low in cost.

The plastic coatings are undergoing changes and improvements in an effort to reduce oxygen permeation which is problematic for foods that have shelf life, flavor and/or nutrient contents that can dramatically deteriorate in contact with oxygen. Many fruit juices show a declining vitamin C content when they are exposed to oxygen.

Barrier layers of gas impermeable materials are provided on that side of the core layer that is on the inner surface of the package (toward the stored product). Experience has shown that superior oxygen impermeability is provided by material such as aluminum foil, ethylene vinyl alcohol (EVOH), nylon, polyvinylidene chloride (PVDC) and polyvinyl alcohol (PVOH).

Although these materials provide benefits and advantages over previously known non-barrier containing packages, they each have their drawbacks. For example, although aluminum foil provides quite acceptable oxygen barrier characteristics, materials that include aluminum foil cannot be easily recycled and can have severe environmental impact. As such, many aluminum foil based materials have been dismissed for use in single-use food packaging.

EVOH and PVOH are highly sensitive to moisture and rapidly lose their barrier characteristics against oxygen gas when they are exposed to a damp environment. Thus, these materials alone are unacceptable for liquid food packaging use when, for example, the packages may be required to have an extended shelf life.

Another problem with packaging materials is referred to as “scalping” in which the flavor from the packaged product is drawn into the package material. This is particularly problematic with LDPE which draws flavors and essential oils (such as the citrus oil d-limonene) from the packaged product into the polyethylene layer. D-limonene has been found to be absorbed into the polyolefin (polyethylene) within the first few weeks following packing. Although this does not have a health-related negative effect or cause any sanitary issues, there is a loss of the beneficial effects of d-limonene. Moreover, because these juices are typically not made from fruit juice concentrates, they do not have flavor additives or enhancers added to the juice to supplement the natural flavor. As a result, the scalping effect of the packaging material cannot be countered by the addition of such flavor enhancers.

In order to counter the scalping effects of LDPE, while at the same time take advantage of the sealing characteristics of LDPE, additional barrier layers have been used adjacent to (inside of) the product contact seal layer. This has been found to be functionally acceptable, however, it has also been found to add material costs, package weight and package and manufacturing complexity.

Accordingly, there exists a need for a laminate packaging material that reduces the scalping associated with many packing materials. Desirably, such a material achieves this while also maintaining high oxygen barrier characteristics to prevent oxidation of the package product. Most desirably such a packaging material achieves the desired low scalping and high oxygen barrier characteristics in a packaging material that uses less material quantities per unit of packaging material (e.g., uses less material weight to manufacture an equivalent square meter (or foot) of the packaging material).

### BRIEF SUMMARY OF THE INVENTION

A low scalping laminate material for food packaging includes a core layer of paper or paperboard having a first side that defines the package exterior and as second side that defines the package interior. A polymeric coating is applied to the first side (the exterior) of the core layer and a food contacting barrier layer is disposed on the second side (the interior) of the core layer.

The laminate packaging material reduces the scalping associated with many packing materials and achieves this reduced scalping while also maintaining high oxygen barrier characteristics to prevent oxidation of the package product. The material achieves both low scalping and high oxygen barrier characteristics in a packaging material that uses no more, and perhaps less material quantities per unit of packaging material, that is, with less material weight to manufacture an equivalent square meter (or foot) of the packaging material.

Preferably, the outer polymeric coating is low density polyethylene (LDPE), medium density polyethylene (MDPE), linear low density polyethylene (LLDPE), metallocene-based linear low density polyethylene (m-LLDPE), or a blend of these.

The food contacting barrier layer is formed from a plurality of series of layers of polymeric materials. Each series of layers includes a polyolefin layer, a tie layer, a polyamide resin layer, a tie layer and a polyolefin layer. The plurality is a whole number greater than one and the layers are applied to provide a weight ratio of materials in each series of 15:46 for each of the polyolefin layers, 5:46 for each of the tie layers and 6:46 for the polyamide resin layer.

In a present material, the polyolefin layer is low density polyethylene (LDPE), medium density polyethylene (MDPE), linear low density polyethylene (LLDPE), metallocene-based linear low density polyethylene (m-LLDPE), or a blend thereof. Preferably, the polyolefin layer is LDPE. The polyamide resin layer is preferably a nylon layer. Most preferably, the nylon is nylon MXD6.

The tie layer is a modified polyolefin. Preferably, the tie layer is an anhydride modified polyolefin, and most preferably, a maleic anhydride modified polyethylene.

The number of series is four or greater, and preferably is a geometric progression of four. In a present material, the total weight of the food contacting barrier layer is 46 grams per square meter of material formed. In a present material, each of the series of layers is identical to each of the other series of layers.

An alternate includes a food contacting barrier layer disposed on the second side of the core layer formed from a plurality of series of layers, each series including a polyamide resin layer, a tie layer, a polyolefin layer and a tie layer, and in which the plurality is a whole number greater than two.

A carton for food storage includes upstanding side walls, a sealed bottom wall, and a sealed top wall. The carton has an interior region for contact with the food that is formed from the low scalping laminate material.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of a typical gable top carton formed from a laminate material embodying the principles of the present invention, the carton being illustrated with a spout-type closure mounted thereto;

FIG. 2 is a cross-sectional illustration of an embodiment of a low scalping laminate material embodying the principles of the present invention;

FIG. 3 is a cross-sectional illustration of an alternate embodiment of the low scalping laminate material of the present invention; and

FIG. 4 is a schematic illustration of a multiplier or microlayer insert configuration for an extruder.

### DETAILED DESCRIPTION OF THE INVENTION

While the present invention is susceptible of embodiment in various forms, there is shown in the drawings and will hereinafter be described a presently preferred embodiments with the understanding that the present disclosure is to be considered an exemplification of the invention and is not intended to limit the invention to the specific embodiments illustrated. It should be further understood that the title of this section of this specification, namely, “Detailed Description Of The Invention”, relates to a requirement of the United States Patent Office, and does not imply, nor should be inferred to limit the subject matter disclosed herein.

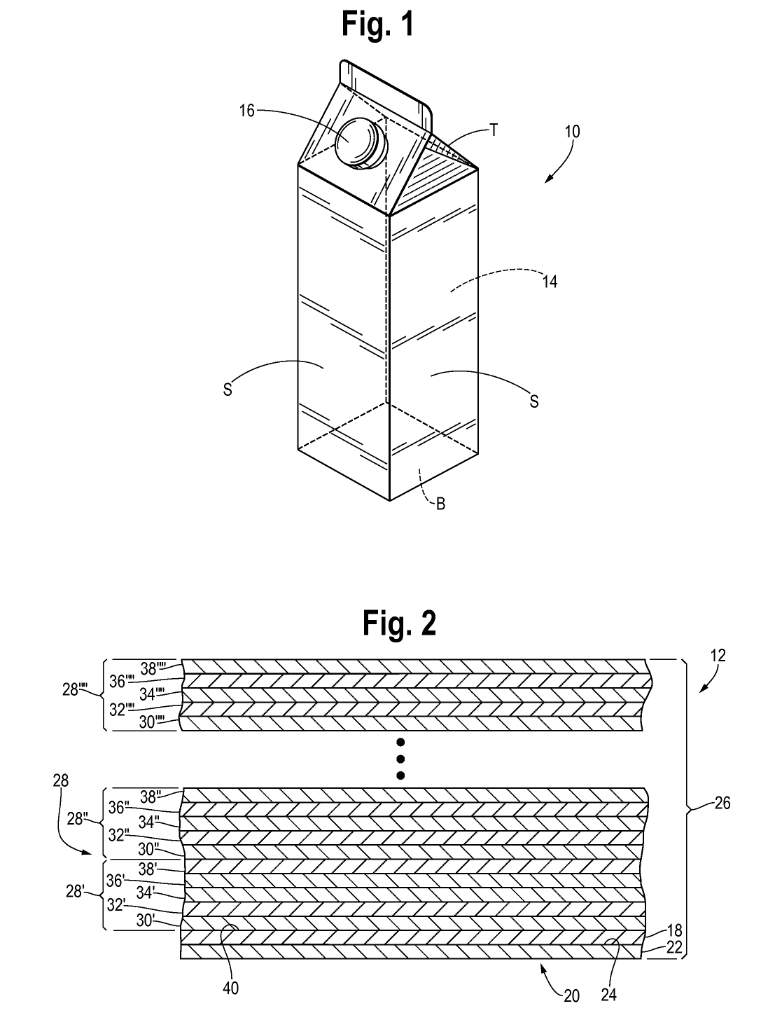

Referring now to the figures and in particular to FIG. 1, there is shown a carton 10 formed from material 12 embodying the principles of the present invention. The illustrated carton 10 is a standard gable top carton and includes four upstanding side walls S (two shown), a sealed bottom wall B (shown in phantom) and a gable top T. It will be appreciated that the present low scalping material 12 can be used for the manufacture of most any type of carton, and is not limited to use for gable top cartons.

The carton 10 defines an interior region, indicated generally at 14, in which product is stored, and is illustrated with a closure 16, such as the exemplary spout type closure that will be recognized by those skilled in the art. The spout closure 16 provides excellent resealability, while maintaining the carton 10 closed to prevent the ingress of oxygen into the carton 10 from the dispensing opening 16.

The carton 10 is formed from a laminated material 12, such as that shown in FIG. 2. The laminated material 12 includes a base or core layer of paper or paperboard material 18. Paper and paperboard materials and their methods of manufacture and use will be recognized by those skilled in the art.

From the core layer 18 to the outside of the carton indicated generally at 20, the material 12 includes a layer of a moisture-resistant polymeric material 22 disposed on an outer surface 24 of the core layer 18. The material 22 is typically a non-polar polymeric material. Presently, one material that is used is LDPE. LDPE is used because of its high-moisture barrier characteristics, relatively low cost and ease of use. LDPE is also approved for use in both food contacting and non-food contacting surfaces for food packaging materials. Also acceptable are linear low density polyethylene (LLDPE) and metallocene-based linear low density polyethylene (m-LLDPE), and blends of these materials.

In the embodiment 12 illustrated in FIG. 2, the inner, food contacting layer, indicated generally at 28, is a novel, micro-structured composite. The composite 26 includes repeating multiples of a five-layer structure or series 28. The structure 28 is symmetrical application of a polyolefin layer 30, a tie layer 32, a polyamide resin layer 34, a tie layer 36 and a polyolefin layer 38. In a present structure 28, the layers 30-38 are a LDPE layer 30, a tie layer 32, a nylon layer 34, a tie layer 36 and a LDPE layer 38.

In a present composite 26, the LDPE layers 30, 38 are a grade 4001i resin, commercially available from Dow Chemical Co., of Midland, Mich. The tie layers 32, 36 are an anhydride modified LDPE, such as BYNEL, Series 4288, commercially available from DuPont, of Wilmington, Del. The tie layers 32, 36 serve as an adhesive between the LDPE layers 30, 38 and the nylon 34. It will be understood that the LDPE layers 30, 38 function as a moisture barrier and as a seal layer.

Due to the method of dividing and stacking the initial LDPE/tie/nylon/tie/LDPE structure, as it comes out of the extruder, a generic barrier structure now becomes a low scalping barrier structure since the nylon is deposited in close proximity to the product. In the present composite 26, the nylon layer 34 serves as a low scalping member, thus preventing the loss of flavor and nutrients (e.g., as in the loss of d-limonene). The nylon layer 34 material (which is an polyamide resin) is commercially available as MXD6 6011 from Mitsubishi Chemical Corporation of Chesapeake, Va. Other nylon materials (such as PA6 and PA6,6, and blends thereof) and tie layer materials will be recognized by those skilled in the art.

The combination of the LDPE 30, tie 32, nylon 34, tie 36, LDPE 38 is applied in a repeating pattern or structure 28, rather than as a single set of layers to form the composite 26. Accordingly, the inside of the packaging material 12 is, when viewed in cross-section, paperboard 18, LDPE 30′, tie 32′, nylon 34′, tie 36′, LDPE 38′, LDPE 30″, tie 32″, nylon 34″, tie 36″, LDPE 38″, . . . , LDPE 30″″, tie 32″″, nylon 34″″, tie 36″″, LDPE 38″″, in a predetermined number n of repeating series 28. This can also be viewed as paperboard 18, (LDPE 30, tie 32, nylon 34, tie 36, LDPE 38)ₙ, wherein n is a whole number multiple. In a present material, the number of series n is a geometric progression of 4 (e.g., n=4, 8, 16, 32, . . . ).

It has been found that this arrangement functions quite well in that the LDPE layers 30, 38 that lie adjacent one another bind or adhere well and that the LDPE layers 30, 38 bind or adhere well to the paperboard 18. In has been observed that the tie layers 32, 36 are needed adjacent the nylon layer 34, in that the nylon 34 and LDPE layers 30, 38 do not adhere well to one another.

The series 28 are applied at a weight that, in the aggregate, is no more than the weight that a single series would be applied. In a present material 12, the aggregate weights of the LDPE-tie-nylon-tie-LDPE are 15-5-6-5-15 grams per square meter of material. In that these are aggregate amounts, if the number of series n is 4, then there are four series 28′-28″″, and each series has layers, 30′-30″″, 32′-32″″, 34′-34″″, 36′-36″″ and 38′-38″″ having a weight of material of 15/4-5/4-6/4-5/4-15/4. Accordingly, each of the layers is also thinner.

It has also been observed that this arrangement functions well to reduce the scalping effect of the LDPE layer 30′ in that the nylon layer 34′ (which is a barrier to scalping) is closer to the product than if a single series (structure) arrangement was used. Thus, because the first nylon layer 34′ is closer to the product, which corresponds to a thinner LDPE layer 30′ or less LDPE in the initial layer contacting the product, the overall scalping effect of the LDPE is greatly reduced. This is because the volume (or mass) of LDPE in the initial layer 30′ that contacts the product is reduced, thus reducing the amount of d-limonene that can be absorbed in that LDPE layer 30′.

In a typical material 12 manufacturing process, the various layers 30, 32, 34, 36, 38 are extruded or coextruded onto the paperboard 18. In order to achieve the serial application or multiple series of LDPE 30—tie 32—nylon 34—tie 36—LDPE 38, a flow multiplier or micro-layer insert (in the die neck) is used, such that the flow stream of each of the layers is divided into the desired number or series. In this manner, if the number of series is 4, then the nylon is divided into four streams of 6/4 or 1.5 gsm (equivalent). A schematic illustration of a multiplier or microlayer feedblock 202 is illustrated in FIG. 4. One example of such a multiplier is that available from Extrusion Dies Industries, of Chippewa Falls, Wis. In a preferred material 12 (and carton or package 10), the structure 28 is formed from only the LDPE layer 30, the adjacent tie layer 32, the adjacent nylon layer 34, the adjacent tie layer 36 and the adjacent LDPE layer 38.

It has been found that by minimizing the polyolefin (LDPE) seal layer 30′ and by placing a barrier layer (nylon) 34′ in close proximity to the inner surface 40 of the seal layer 30′, scalping of the flavor oils (e.g., d-limonene) can be reduced. With the use of a micro-layer structure 28′, 28″, 28′″, 28″″, . . . , 28n, a barrier 12 formed from standard and known materials can be provided that is applied in multiple thin layers distributed throughout the entirety of the layered structure (the material laminate 12) to achieve lower scalping characteristics. The overall result of the micro-layered structure 28′, 28″, 28′″, 28″″, . . . , 28ⁿ can be a lower cost package material (due to a possible reduction in nylon application from 9-11 gsm to 5-7 gsm), the creation of a tortuous path (by multiple layers) for the ingress or penetration of oxygen, enhanced strength with layering reduces the possibility of pinholes, the extrusion of more (a larger number of) thinner layers of material, and an improved stacked alignment of fillers (such as talc, calcium carbonate, nanoclays and the like) that may be added to one or more of the layers. The thinner layers provide better dispersion of the filler material and reduce the opportunity for the filler materials to clump (uneven distribution) or to improperly orient within the material layer.

Also advantageously, it has been found that extruding thinner LDPE layers 30, 38 improves the overall strength of the material. In addition, it has been found that MXD6 (as the nylon layer 34), which is brittle in extrusion coating and is otherwise challenging to extrude alone, when extruded in thinner layers between the also thinner olefin layers 30, 38, tends to be more workable and shows improved converting performance.

It will be appreciated that although specific materials are disclosed for the LDPE 30, 38, tie 32, 36 and nylon 34 layers, other suitable materials can be used in the present microlayer low scalping barrier packaging material 12. For example, suitable materials for the barrier, nylon layer 34, can include ethylene vinyl alcohol (EVOH) or other like oxygen barriers. Olefins other than LDPE can be used for the olefin layer 32, 38, for example, olefins having a density of about 0.0922-0.0924 will also likely be suitable.

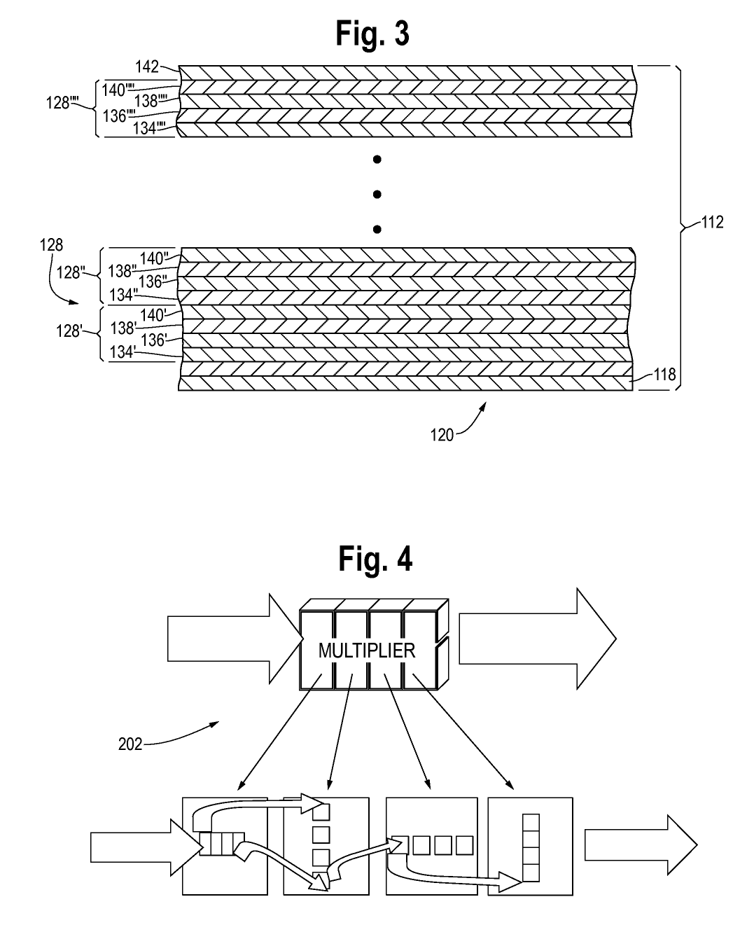

An alternate embodiment of the laminated material 112 is illustrated in FIG. 3. In this embodiment, each series 126 includes a nylon layer 134, a tie layer 136, a LDPE layer 138 and a tie layer 140, or (nylon 134, tie 136, LDPE 138, tie 140)ₙ. In this arrangement, the nylon layer 134 is in contact with the paperboard 118. The final tie layer 140 can serve as a seal layer. Alternately, as seen in FIG. 3, a layer 142 of LDPE, LLDPE or other material can serve as a final “cap” layer. The micro-layering or microstructure layering 128′, 128″, . . . , 128″″ is, however, the same as that of the embodiment of FIG. 2. It is anticipated that the same materials will also be used in this embodiment 112.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A low scalping laminate material for food packaging comprising:
a core layer of paper or paperboard having a first side and as second side;
a polymeric coating applied to the first side of the core layer; and
a food contacting barrier layer disposed on the second side of the core layer, the food contacting barrier layer formed from a plurality of series of layers of polymeric materials, each series of layers including a polyolefin layer, a tie layer, a polyamide resin layer, a tie layer and a polyolefin layer,
wherein the plurality is a whole number greater than one and wherein the layers are applied to provide a weight ratio of materials in each series of 15:46 for each of the polyolefin layers, 5:46 for each of the tie layers and 6:46 for the polyamide resin layer.

2. The low scalping laminate material in accordance with claim 1 wherein the polyolefin layer is one of low density polyethylene (LDPE), medium density polyethylene (MDPE), linear low density polyethylene (LLDPE), metallocene-based linear low density polyethylene (m-LLDPE), and blends thereof.

3. The low scalping laminate material in accordance with claim 2 wherein the polyolefin layer is LDPE

4. The low scalping laminate material in accordance with claim 1 wherein the polyamide resin layer is a nylon layer.

5. The low scalping laminate material in accordance with claim 4 wherein the nylon is nylon MXD6.

6. The low scalping laminate material in accordance with claim 1 wherein the number of series is four or greater.

7. The low scalping laminate material in accordance with claim 6 wherein the number of series is a geometric progression of four.

8. The low scalping laminate material in accordance with claim 1 wherein the total weight of the food contacting barrier layer is 46 grams per square meter of material formed.

9. The low scalping laminate material in accordance with claim 8 wherein the number of series is four or a geometric progression of four.

10. The low scalping laminate material in accordance with claim 1 wherein the tie layer is a modified polyolefin.

11. The low scalping laminate material in accordance with claim 10 wherein the modified polyolefin is an anhydride modified polyolefin.

12. The low scalping laminate material in accordance with claim 11 wherein the anhydride modified polyolefin is a maleic anhydride modified polyethylene.

13. The low scalping laminate material in accordance with claim 1 wherein the polymeric coating applied to the first side of the core layer is one of low density polyethylene (LDPE), linear low density polyethylene (LLDPE), medium density polyethylene (MDPE), metallocene-based linear low density polyethylene (m-LLDPE), and blends thereof.

14. The low scalping laminate material in accordance with claim 1 wherein each of the series of layers is identical to each of the other series of layers.

15. A low scalping laminate material for food packaging comprising:
a core layer of paper or paperboard having a first side and as second side;
a polymeric coating applied to the first side of the core layer; and
a food contacting barrier layer disposed on the second side of the core layer, the food contacting barrier layer formed from a plurality of series of layers of polymeric materials, each series of layers including a polyamide resin layer, a tie layer, a polyolefin layer and a tie layer,
wherein the plurality is a whole number greater than two.

16. The low scalping laminate material in accordance with claim 15 wherein the polyamide resin layer is a nylon layer.

17. The low scalping laminate material in accordance with claim 15 including a seal layer on an outermost tie layer.

18. The low scalping laminate material in accordance with claim 17 wherein the seal layer is a polyolefin.

19. A low scalping carton for food storage comprising:
upstanding side walls;
a sealed bottom wall; and
a sealed top wall,
the carton having an interior region for contact with the food, the carton formed from a low scalping laminate material, the low scalping material including a core layer of paper or paperboard having a first side defining an outer surface of the carton and a second, food contacting side, the second, food contacting side defining a barrier layer and formed from a plurality of series of layers of polymeric materials, each series of layers including a polyolefin layer, a tie layer, a polyamide resin layer, a tie layer and a polyolefin layer,
wherein the plurality is a whole number greater than one and wherein the layers are applied to provide a weight ratio of materials in each series of 15:46 for each of the polyolefin layers, 5:46 for each of the tie layers and 6:46 for the polyamide resin layer, and
wherein the polymeric coating applied to the first side of the core layer is one of low density polyethylene (LDPE), linear low density polyethylene (LLDPE), medium density polyethylene (MDPE), metallocene-based linear low density polyethylene (m-LLDPE), and blends thereof.

20. The low scalping carton in accordance with claim 19 wherein the polyolefin layer is one of low density polyethylene (LDPE), linear low density polyethylene (LLDPE), medium density polyethylene (MDPE), metallocene-based linear low density polyethylene (m-LLDPE), and blends thereof.

21. The low scalping carton in accordance with claim 20 wherein the polyolefin layer is LDPE.

22. The low scalping carton in accordance with claim 19 wherein the polyamide resin layer is a nylon layer.

23. The low scalping carton in accordance with claim 22 wherein the nylon is nylon MXD6.

24. The low scalping carton in accordance with claim 19 wherein the number of series is four or greater.

25. The low scalping carton in accordance with claim 24 wherein the number of series is a geometric progression of four.

26. The low scalping carton in accordance with claim 19 wherein the total weight of the food contacting barrier layer is 46 grams per square meter of material formed.

27. The low scalping carton in accordance with claim 19 wherein the modified polyolefin is an anhydride modified polyolefin.

28. The low scalping carton in accordance with claim 19 wherein each of the series of layers is identical to each of the other series of layers.
